(19) United States
(12) Patent Application Publication
(10) Pub. No.: US 2006/0210694 A1
(43) Pub. Date: Sep. 21, 2006

(54) Anti-caking agents and methods

(76) Inventors: Rulon A. Chappell, North St. Paul, MN (US); Donald A. Grindstaff, Apple Valley, MN (US); Adam R. Woodworth, Keokuk, IA (US)

Correspondence Address: Mark Hagedorn;Barnes & Thornburg, P.O. Box 2786, Chicago, IL, 60606, US

(21) Appl. No.: 11/083,741

(22) Filed: Mar. 18, 2005

(51) Int. Cl. A21D 2/16

(52) U.S. Cl. 426/654

(57) ABSTRACT

An anti-caking agent and methods of manufacture and use comprising a free-flowing powder blend comprising an absorbent powder material and a base liquid. The anti-caking agent is manufactured by providing an absorbent powder material, agitating the absorbent powder material and applying a base liquid while continuously agitating. A method of using the inventive anti-caking agent comprises providing a divided food product and applying to the divided food product an anti-caking agent comprising a free-flowing blend comprising an absorbent powder material and a base liquid.

### BACKGROUND

The present disclosure relates to anti-caking agents, food compositions including anti-caking agents, methods of manufacturing anti-caking agents and methods of treating divided products for anti-caking. The anti-caking agents and methods disclosed herein are particularly suited for use with food products, such as divided dairy products including but not limited to shredded, grated, diced, cubed or chunked cheese products.

Anti-caking agents are used, particularly for the institutional market, to reduce the adherence of substances during transportation and storage prior to their intended use. Many food products are processed into smaller unit sizes, i.e., powdered, granulated, shredded, etc., to benefit their ease of use. Anti-caking additives have been used in powdered products, such as powdered milk, powdered soups, etc., granulated substances such as table salt, and shredded products, such as cheese to reduce unwanted agglomeration and enhance the flow characteristics. Cheese products in particular are often produced in large units that are further processed by dividing, i.e., shredding, dicing or chunking, for use in food product applications. Untreated, many forms of food products will agglomerate or lump together thereby adversely affecting their use in further food product applications or resulting in an undesirable consumer food product. Divided cheese products, particularly high moisture and high fat cheeses, are very susceptible to such unwanted agglomeration and require an anti-caking additive to maintain the discrete particles and provide for flowability.

Several anti-caking agents used to reduce the adherence of individual food product particles and to enhance the flow characteristics of such food products are commercially available. These conventional agents include celluloses, starches, flours, clays, such as bentonite, metal carbonates, such as calcium carbonate, and silicon dioxide. The pre-existing anti-caking additives have several drawbacks, particularly for the divided food product industry.

The divided food product industry desires an anti-caking agent that reduces agglomeration and enhances product flow characteristics, but does not hinder or adversely affect the cheese products' desired application and organoleptic properties. Cellulose is currently used as the preferred anti-caking agent of choice for the institutional (pizza) divided cheese market. Cellulose can be used at low application levels, about 1.5% by weight or below, without having adverse effects on the cheese. Application levels above about 1.5% are not useful because the melt properties of the cheese are adversely affected. Further, cellulose is not a process-friendly material from the divided food product manufacturer's perspective because of its dustiness and its inability to be forgiving to cheese melt properties if higher application levels are reached.

Starch-based anti-caking agents are not preferred for the institutional market. Starch-based anti-caking agents allow the cheese to melt, but the starch-based additives cause excess browning of the cheese when baked. During the baking process, the cheese releases moisture causing evaporative cooling on the surface of the cheese. This evaporative cooling, in effect, allows the surface of the cheese to maintain a temperature that is sufficient to inhibit excess browning. Starch-based anti-caking agents compete for the moisture in the cheese during baking because starches start to gelatinize at temperatures that are achieved in the early stages of baking. When the starch gelatinizes, it takes on available water until its saturation point is achieved. The moisture uptake by starch reduces the amount of evaporative cooling on the surface of the cheese. This causes hot spots on the cheese to form, and undesirable browning occurs. Although excess browning may not be as noticeable with regular convection ovens, such as those being used in the home, it is exacerbated when forced air convection ovens are used, as in most fast food pizza restaurants and by consumer food product manufacturers. The forced air also drives the moisture off of the surface of the cheese, further worsening the starch's effects on browning. Thus, starch-based anti-caking agents are not preferred when forced air ovens are used.

Silicon dioxide has been used in the past as an anti-caking agent, but it is extremely dusty, is a respiratory nuisance, and worsens cleanup of equipment. Because silicon dioxide is hydrophilic, depending on the variety, it dries out the cheese surface in storage causing hard, unpleasant cheese texture.

### BRIEF SUMMARY OF THE DISCLOSURE

Briefly, the present disclosure provides an anti-caking agent comprising a dry, free-flowing powder comprising a blend of a powdered absorbent component and a base liquid. A method of manufacturing an anti-caking agent is disclosed comprising adding a base liquid to a powdered absorbent component to form a free-flowing powder. A method of treating a divided food product to reduce agglomeration is disclosed comprising contacting a divided food product with an anti-caking agent comprising a free-flowing powder blend of a powdered absorbent material and a base liquid. A preferred powdered absorbent material comprises silicon dioxide powder.

### DETAILED DESCRIPTION

While the present disclosure may be susceptible to embodiments in different forms, herein will be described in detail, an embodiment with the understanding that the present description is to be considered an exemplification of the principles of the disclosure and is not intended to limit the disclosure to that as described herein.

The present disclosure includes an anti-caking agent comprising a free-flowing powder blend comprising an absorbent powder material and a base liquid. The absorbent powder material may be selected from absorbent substances capable of holding moisture, including but not limited to silicon dioxide, silicates, clays, powdered cellulose, and diatomaceous earth materials. The presently preferred absorbent powder material comprises silicon dioxide (SiO2), more preferably hydrophilic silicon dioxide. The silicon dioxide or other absorbent powder material preferably can have an average particle size from about 1 to about 100 microns, preferably about 4 microns to about 50 microns, more preferably about 10 microns to about 20 microns. An exemplar absorbent powder material is silicon dioxide sold by Degussa Corporation under the trade name Sipemat 320. The absorbent powder material preferably comprises from about 10 to about 80% by weight of the free-flowing powder blend, more preferably about 30 to about 60%, still more preferably about 35 to about 45%, and most preferably about 40%.

The disclosed anti-caking agent further comprises a base liquid. As used herein, the term “base liquid” means a liquid that comprises greater than 5% by weight of the total absorbent powder material and liquid. Preferably, the base liquid is aqueous, but other liquids such as oils, alcohols, sugars, polyols, emulsifiers, juices, milk, humectants and the like may be used. The base liquid preferably comprises from about 90 to about 20% by weight of the powder blend. More preferably, the base liquid comprises about 70 to about 40%, even more preferably from about 65 to about 55%, and still more preferably comprises about 60% of the powdered blend based on the total weight of the base liquid and the absorbent powder material. Additional materials, particularly components soluble or otherwise dispersible in the base liquid such as anti-mycotics, colorings, flavorings and organic acids, may be added to the base liquid.

The base liquid is absorbed by the absorbent powder material, which in turn reduces the absorbent powder material's ability to draw moisture out of food products resulting in more desirable end products. Further, the additional moisture level alleviates the dust levels of the absorbent powder material and thereby reduces the respiratory risks that such materials had traditionally placed on the users of such materials. The addition of base liquid to the absorbent powder material advantageously provides increased moisture delivery to a divided cheese product, thereby minimizing the undesirable browning that occurs in forced-air convection ovens, as with traditional starch-based anti-caking agents.

The anti-caking agent may be used alone or may be blended with other materials including other anti-caking materials. Additional ingredients or materials, particularly materials soluble in or otherwise compatible with the base liquid, may be added to the powdered blend, such as anti-mycotics, antimicrobials, colorants, dyes, flow agents, food flavorings, enzymes, vitamins, emulsifying agents, polydimethylsiloxane, organic acids and fiber, which may be desirable in the food product or further enhance desirable properties. Preferably, the base liquid includes an anti-mycotic, such as natamycin, or a salt.

A preferred embodiment includes a base liquid further including a salt to form a salt brine solution. The salt may be selected from food grade salts, including sodium chloride, potassium chloride, sodium nitrite, magnesium nitrate, potassium carbonate and magnesium chloride, with sodium chloride being preferred. The salt is dissolved in the base liquid such that the salt content comprises between about 1 to about 60% by weight of the salt brine solution, preferably such that the salt content is from about 10 to about 40% by weight of the salt brine solution, and more preferably about 20-30% by weight of the salt brine solution. The salt acts to inhibit microbial growth in the high moisture environment of the anti-caking agent. Additionally, the salt acts to reduce the water activity in the anti-caking agent. The salt brine solution is present in the free-flow powder blend at levels from about 20 to about 90% by weight, preferably about 50 to about 70%, more preferably from about 55 to about 65%, and still more preferably about 60%.

The preferred method of formulating the free-flowing powder blend comprises providing an absorbent powder material and agitating the powder material. The agitation can be carried out in a batch process using a blender, or may be a fluidized bed. While the absorbent powder material is agitated, the base liquid is poured or sprayed onto the absorbent powder material. The combination is continuously agitated until a substantially homogenous distribution is achieved. Conversely, the base liquid may be provided and agitated while the powder material and any additional ingredients are subsequently added, but this is not preferred. Additional materials may be added to the anti-caking agent by addition to the free-flowing powder blend or by application to the absorbent powder material prior to application of the base liquid, particularly if the additional ingredient is a free-flowing powder substance. If additional materials are desired that would be adversely affected by addition prior to the addition of the salt brine solution, then those elements are preferably added to the free-flowing powder blend after the salt brine solution has been applied to the absorbent powder material. Preferably, flow agents, such as hydrophobic materials, including hydrophobic silicas, silicates, phosphates, carbonates, etc., and additional ingredients are added after combining the absorbent powder material and the base liquid or salt brine solution.

In another preferred embodiment, the anti-caking agent further includes a flow agent. Preferably, the flow agent is selected from hydrophobic materials such as hydrophobic silicas and silicates. The flow agent can also be selected from materials such as phosphates, carbonates, sulfates, starches, proteins and oil-based powdered materials. The flow agent is preferably present in an amount of from about 0.01% to about 5%, and more preferably from about 0.1% to about 2% by weight based on the total weight of the anti-caking agent.

The anti-caking agent of the present disclosure is preferably applied to a food product susceptible to agglomeration, such as divided cheese products. A preferred method of treating a divided food product for anti-caking comprises providing a divided food product; providing an anti-caking agent comprising a free-flowing powder blend comprising an absorbent powder material and a base liquid; and, dispersing the anti-caking agent over the divided food product to inhibit agglomeration. The divided food product may include any product, and may be divided in any manner.

The anti-caking agent, together with additional ingredients blended with the anti-caking agent, if any, is applied to food products at levels sufficient to prevent caking. Preferably, the anti-caking agent is applied to a food product at a level of about 0.1 to about 10% by weight based on total weight of the finished food product. More preferably, the anti-caking agent is applied at a level of about 0.5 to about 5%. The anti-caking agent may be applied to food products in conventional manners known to those of skill in the art, including by application in a tumble drum apparatus.

In a further embodiment of the disclosure, a food composition is provided. The food composition comprises a divided food product having a plurality of individual food particles; and, an anti-caking agent dispersed on the individual food particles in an amount sufficient to inhibit agglomeration of said food product. The anti-caking agent comprises a free-flowing powder blend comprising an absorbent powder material and a base liquid as disclosed and described above. Preferably, the divided food product comprises a divided cheese product. More preferably, the divided cheese product comprises a shredded cheese suitable for use in making pizza products. Preferably, the anti-caking agent is applied to the divided food product at a level of about 0.1 to about 10% by weight based on total weight of the finished food composition. More preferably, the anti-caking agent is applied at a level of about 0.5 to about 5%. The anti-caking agent may be applied to divided food products in conventional manners known to those of skill in the art, including by application in a tumble drum apparatus.

The following examples describe and illustrate certain aspects of the anti-caking agents and methods of the present disclosure. These examples are intended to be merely illustrative of the present disclosure, and not limiting thereof in scope.

### EXAMPLE 1

In this example, three anti-caking agents including an anti-caking agent of the present disclosure were tested to determine the effectiveness of the three different formulations on the flowability of shredded cheese at certain application levels. The agents were: (1) a free-flowing powder blend of the present disclosure comprising 33% by wt. hydrophilic silicon dioxide and 67% by wt. salt brine solution, wherein the salt brine solution comprised 85% by wt. water and 15% by wt. sodium chloride; (2) powdered cellulose; and (3) a 70% potato starch/30% powdered cellulose blend.

Blocks of low moisture, part skim mozzarella cheese were acquired from a local supermarket and shredded using a Cuisinart Food Processor with a medium shredding disk. Each of the three anti-caking agents were applied to 250 grams of the cheese at levels of 1, 2, 3 and 4% by wt. and thoroughly mixed. The cheese was then visually evaluated based on its ability to flow freely from a tilted bag. If cheese particles remained separate without falling in clumps, the shredded cheese was determined to have excellent flow properties. The greater the level of clumping results in a less favorable rating. The results are as follows:

APPLICATION RATE (% by wt.)

| AGENT | 1% | 2% | 3% | 4% |
|---|---|---|---|---|
| (1) SiO₂/Brine | *** | **** | **** | **** |
| (2) Cellulose | **** | **** | **** | **** |
| (3) Starch/Cellulose | *** | **** | **** | **** |

**** = Excellent flow
*** = Good flow
** = Fair flow
* = Poor flow

The results of Example 1 indicate that all anti-caking agents tested performed good or excellent at all application levels. Cellulose gave the cheese excellent flowability at all application levels, whereas the silicon dioxide/brine formula and the potato starch/cellulose formula gave good flowability at 1% and excellent at 2, 3, and 4% application rates. The shredded cheese market requires anti-caking agents that allow free flowing cheese shreds.

### EXAMPLE 2

In Example 2, the same agents as were used in Example 1 were tested to determine the visibility of the agents at application levels of 1, 2, 3, and 4%. The same procedures and methods in Example 1 were followed for this example. After mixing, the cheese was examined for the visibility of the anti-caking on the surface of the shreds. The results were as follows:

APPLICATION RATE (% by wt.)

| AGENT | 1% | 2% | 3% | 4% |
|---|---|---|---|---|
| (1) SiO₂/Brine | **** | **** | *** | *** |
| (2) Cellulose | *** | ** | * | * |
| (3) Starch/Cellulose | **** | *** | *** | ** |

**** = Mostly invisible
*** = Low visibility
** = Visible
* = Excessive visibility

The results of Example 2 show that agent (1), the silicon dioxide/brine formula of the present invention, stays mostly invisible at 1 and 2% and retains low visibility at 3 and 4%. The cellulose has low visibility at 1% but becomes visible at 2% and is not acceptable at 3 and 4%. The potato starch/cellulose blend is mostly invisible at 1%, retains low visibility at 2 and 3%, and becomes visible at 4%. Visibility of the anti-caking agent on the shreds is not acceptable for the consumers of the cheese. The consumers often confuse the visible anti-caking as mold growing on the cheese, thus anti-caking agents that are mostly invisible or retain low visibility at all application rates are desirable.

### EXAMPLE 3

In Example 3, the same agents as used in Examples 1 and 2 were tested to determine the browning characteristics upon baking. The same procedures and methods in Example 1 were followed for this example. The cheese with anti-caking agent was then placed onto a pre-sauced 12″ par-baked pizza crust and baked in a Lincoln Impinger oven for 5 minutes at 450° F. A control pizza using the same cheese without anti-caking agent was made. After baking, the pizzas were visually compared and the results are provided below.

APPLICATION RATE (% BY WT.)

| AGENT | 1% | 2% | 3% | 4% |
|---|---|---|---|---|
| (1) SiO2/Brine | **** | **** | **** | *** |
| (2) Cellulose | **** | *** | *** | ** |
| (3) Starch/Cellulose | ** | * | * | * |

**** = Excellent acceptability
*** = Good acceptability
** = Fair acceptability
* = Poor acceptability

The results of Example 3 show that agent (1), the free-flowing silicon dioxide/brine formula of the present disclosure, caused the least amount of browning through the range of application. Cellulose acceptability decreased quicker than the agent (1) silicon dioxide/brine formula, while agent (3), the starch/cellulose blend, had the most unacceptable browning. The pizza including agent (1) had an appearance similar to the control throughout the range of application, whereas the cellulose and potato starch/cellulose pizzas had more pronounced browning. Excessive browning is not desirable on a pizza. An anti-caking agent that does not cause excessive browning is preferred in the institutional market.

### EXAMPLE 4

Example 4 is designed to determine the effects that the three anti-caking agents from Example 3 had on the melt of the cheese. The pizzas were prepared similar to Example 3, using the same agents, methods and equipment. After baking, the pizzas were compared and the results were as follows:

APPLICATION RATE (% by wt.)

| AGENT | 1% | 2% | 3% | 4% |
|---|---|---|---|---|
| (1) SiO₂/Brine | **** | **** | *** | *** |
| (2) Cellulose | **** | ** | * | * |
| (3) Starch/Cellulose | **** | *** | ** | ** |

**** = Excellent melt
*** = Good melt
** = Fair melt
* = Poor melt

The results of Example 4 show that the three agents performed equally well at 1%. The pizzas using the (1) silicon dioxide/brine agent of the present disclosure achieved the most acceptable melt at application ranges above 1%, followed by the potato starch/cellulose blend and then the cellulose. The (1) silicon dioxide/brine agent caused the pizza cheese to melt most like the control. Consumers expect a pizza to melt properly. Mozzarella is the most widely used cheese for pizza in the institutional market because of its melt properties, and anti-caking agents that reduce the meltability of mozzarella are not desirable.

### EXAMPLE 5

Example 5 is designed to compare the ratio of salt brine solution to silicon dioxide required to reduce the dustiness of the free-flowing powder agent while still being free-flowing. Anti-caking agent samples were prepared by adding a salt brine solution comprising 85% by wt. water and 15% by wt. sodium chloride to hydrophilic silicon dioxide at 5 percent increments from 50% to 75% of the final weight of the anti-caking agent. The silicon dioxide used was Sipernat 50 from Degussa Corporation. The results were as follows:

| Brine % (by wt. of total | | |
|---|---|---|
| agent) | Dust prevention | Flow |
| 0% brine | * | **** |
| 50% brine | ** | **** |
| 55% brine | ** | **** |
| 60% brine | *** | *** |
| 65% brine | *** | ** |
| 70% brine | **** | * |
| 75% brine | **** | * |

**** = Excellent
*** = Good
** = Fair
* = Poor

The data shows that increasing the brine level results in the amount of dust being decreased, but also results in decreased flowability of the final anti-caking agent. A 60% brine to 40% silicon dioxide ratio, by weight, was determined to be the optimal ratio with regards to reducing the dust to an acceptable level while still retaining good flowability.

### EXAMPLE 6

In Example 6, anti-caking agent formulations according to the present disclosure were tested to determine the optimal silicon dioxide to use in the preferred silicon dioxide/salt brine solution formula. Four silicon dioxides from Degussa Corporation with differing particle sizes and moisture absorptions were used. A 15% salt brine solution as described in Example 5 was added to the silicon dioxides at a ratio of 60% by weight salt brine solution to 40% by weight silicon dioxide. Dustiness and flowability of the final anti-caking agents were analyzed visually. The formulas were then added to pizzas and baked in the same manner as set forth in Example 3. The mouth feel of the cheese was then determined. The results were as follows:

| | Average | Moisture | Dust | | |
|---|---|---|---|---|---|
| | Particle size | Absorption | pre- | | Mouth feel |
| SiO2 | (um) | (g/100 g) | vention | Flow | of cheese |
| Sipernat 50 | 50 | 335 | **** | *** | ** |
| Sipernat 320 | 15 | 225 | *** | *** | **** |
| Sipernat 50S | 7.5 | 325 | ** | ** | **** |
| Sipernat 22S | 7 | 265 | ** | ** | **** |

**** = Excellent
*** = Good
** = Fair
* = Poor

The results of Example 6 show that silicon dioxides with larger particle sizes are preferred to reduce dust and retain flowability. However, larger particle sizes detract from the preferred mouth feel of the cheese after baking. It was determined that Sipernat 320 would be an acceptable silicon dioxide to use to prevent dustiness and retain flowability, while keeping the mouth feel of the cheese more natural after baking.

While various embodiments of the disclosure are herein described, it is envisioned that those skilled in the art may devise various modifications and equivalents without departing from the spirit and scope of the disclosure. The disclosure is not intended to be limited by the foregoing detailed description.

What is claimed is:

1. An anti-caking agent comprising a blend of:
an absorbent powder material; and,
a base liquid;
whereby blending of the absorbent powder material and said base liquid forms a free-flowing powder.

2. The anti-caking agent of claim 1 wherein said absorbent powder material of the blend comprises from about 80% to about 10% by weight of said blend based on the total weight of said absorbent powder material and said base liquid.

3. The anti-caking agent of claim 1 wherein said absorbent powder material is selected from the group consisting of silicon dioxide, silicates, clays, cellulose materials and diatomaceous earth materials.

4. The anti-caking agent of claim 1 wherein said absorbent powder material comprises silicon dioxide.

5. The anti-caking agent of claim 1 wherein said base liquid further includes a salt to form a brine solution.

6. The anti-caking agent of claim 5 wherein said base liquid comprises an aqueous liquid and said salt comprises sodium chloride, and said brine solution comprises from about 20% to about 90% by weight of said anti-caking agent based on the total weight of said absorbent powder material and said salt brine solution.

7. A method of manufacturing an anti-caking agent comprising a free-flowing powder, the steps of the method comprising:
providing an absorbent powder material;
providing a base liquid;
mixing said absorbent powder material and said base liquid under agitation.

8. The method of claim 7 wherein said absorbent powder material is selected from the group consisting of silicon dioxide, silicate, clay, powdered cellulose and diatomaceous earth material.

9. The method of claim 7 wherein said absorbent powder material comprises silicon dioxide.

10. The method of claim 7 wherein said base liquid comprises an aqueous solution of water and sodium chloride.

11. A method of treating a food product for anti-caking, the steps of the method comprising:
providing a divided food product;
providing an anti-caking agent comprising a free-flowing powder blend of an absorbent powder material and a base liquid; and,
dispersing said anti-caking agent over said divided food product to inhibit agglomeration.

12. The method of claim 11 wherein said absorbent powder material is selected from the group consisting of silicon dioxide, silicate, clay, powdered cellulose and diatomaceous earth material.

13. The method of claim 11 wherein said absorbent powder material comprises silicon dioxide.

14. The method of claim 11 wherein said absorbent powder material comprises silicon dioxide and said silicon dioxide comprises about 10 to about 80% by weight of the free-flowing powder material.

15. The method of claim 11 wherein said base liquid comprises an aqueous solution of water and about 1 to about 60% by weight salt.

16. A food composition comprising:
a divided food product comprising a plurality of individual food particles; and
an anti-caking agent dispersed on said individual food particles in an amount sufficient to inhibit agglomeration of said food product, said anti-caking agent comprising a free-flowing powder blend comprising an absorbent powder material and a base liquid.

17. The food composition of claim 16 wherein said absorbent powder material is selected from the group consisting of silicon dioxide, silicate, clay, powdered cellulose and diatomaceous earth material.

18. The food composition of claim 16 wherein said absorbent powder material comprises silicon dioxide.

19. The food composition of claim 16 wherein said base liquid comprises an aqueous solution of water and about 1% to about 60% by weight salt.

20. The food composition of claim 16 wherein said divided food product comprises a cheese product.
